(19) United States
(12) Patent Application Publication
(10) Pub. No.: US 2024/0411912 A1
(43) Pub. Date: Dec. 12, 2024

(54) MANAGING ACCESS TO DATA

(71) Applicant: Sage Global Services Limited, Tyne and Wear (GB)

(72) Inventors: Klaus-Michael Vogelberg, Tyne and Wear (GB); Richard Gwynne Morgan, Tyne and Wear (GB)

(73) Assignee: Sage Global Services Limited, Tyne and Wear (GB)

(21) Appl. No.: 18/702,943

(22) PCT Filed: Oct. 19, 2022
(86) PCT No.: PCT/GB2022/052667

§ 371 Date: Apr. 19, 2024

(30) Foreign Application Priority Data
Oct. 20, 2021 (GB) 2115038.8

(51) Int. Cl. G06F 21/62; G06F 21/60; H04L 9/14

(52) U.S. Cl. CPC G06F 21/6218; G06F 21/602; H04L 9/14

(57) ABSTRACT

A system and a method for managing access to data in a distributed computing system. The system includes at least one server computer including a memory device configured to store encrypted data associated with a client; and at least one client device configured to request to process the encrypted data. The client device is configured to retrieve encryption data indicative of an encryption key associated with the encrypted data from a secure storage device associated with the client, and transmit, to the server computer a request to process the encrypted data and the encryption key. The server computer is configured to, responsive to receiving the request: retrieve the encrypted data, decrypt the encrypted data using the encryption key, and fulfil the processing request to determine processed data.

This invention relates to managing access to data in a distributed computing system. Aspects of the invention relate to a system for managing access to data in a distributed computing system, a client device for managing a request to process user data in a distributed computing system, and a computer implemented method of managing access to data in a distributed computing system.

### BACKGROUND

The use of distributed computing systems is becoming increasingly common, both for personal and enterprise users. Distributed computing systems typically comprise a server in communication with client devices via a network. They provide applications and/or services on the servers which may be accessed by user devices. At least part of the application is provided by a server, typically a remote server, and not on local devices. In a typical distributed application, a user device, which may be referred to as a client device, may transmit data to the server for processing, then depending on the type of processing, the server will either store the processed data and/or return the processed data to the client. A cloud service is an example of a distributed computing system, in which remote servers are accessed via the internet.

Many distributed computing applications, including cloud applications, rely on the server having full control over the data it manages and processes. The server authenticates the client access requests and authorises individual client access requests. This is acceptable when the owner of the data, who may be referred to as the data controller, has full control over the server. However, in a Software as a Service (SaaS) business model where the server is operated by a third party, this authentication responsibility is transferred to the third party operator of the server, who may be referred to as a data processor. This arrangement can lead to a disparity between the client who legally owns the data but has no technical control over it, and the third party who operates the server and does not own the data but requires full control for technical reasons.

A server cannot technically process data without having access to the same data. Using a multitenant database design, where a single instance of the application is running on the server serving multiple tenants (i.e. clients) means that the SaaS vendor has complete and permanent access control over all client data, but so will have a malicious actor who successfully breaks in.

It is an aim of the present invention to address one or more of the disadvantages associated with the prior art.

### BRIEF SUMMARY OF THE DISCLOSURE

Aspects and embodiments of the invention provide a system for managing access to data in a distributed computing system, a client device for managing a request to process user data in a distributed computing system, a computer-implemented method of managing access to data in a distributed computing system, and computer software as claimed in the appended claims.

According to an aspect of the present disclosure there is provided a system for managing access to data in a distributed computing system, comprising: at least one server computer comprising a memory device configured to store encrypted data associated with a client; and at least one client device configured to request to process the encrypted data by: retrieving encryption data indicative of an encryption key associated with the encrypted data from a secure storage device associated with the client, and transmitting to the server computer a request to process the encrypted data and the encryption key; wherein the server computer is configured to, responsive to receiving the request: retrieve the encrypted data, decrypt the encrypted data using the encryption key, and fulfil the processing request to determine processed data.

In this way the client, who is the owner of the data, maintains control of the data even while it is stored at a server that may not be owned or controlled by the client. The client can prevent parties with access to the server from accessing their client data stored thereon.

The server computer may be configured to delete the encryption key from the server computer following completion of the processing request. The server computer may be configured not to persist the encryption key following completion of the processing request. This provides additional security to prevent parties with access to the server from accessing their client data stored thereon.

In an embodiment, the distributed computing system comprises a cloud service. The server computer may be provided by a cloud server. The cloud service and/or cloud server may be operated by a third party.

Optionally, the server computer is further configured to deliver the processed data to a requested destination. The server computer may be configured to encrypt the processed data prior to delivery. Delivery of the processed data may include returning the process data to the client, or storing the process data at the server. The server may be configured to re-encrypt the processed data and transmit it to the client. The server may be configured to save the processed data in an encrypted or unencrypted format. Where encrypted processed data is being returned to the client, the encryption key may be deleted after the processed data is returned to client device and encrypted on the server computer.

The memory device may be configured to store both encrypted data associated with the client and unencrypted data associated with that client.

Optionally, the system further comprises the secure storage device configured to store the encryption data indicative of the encryption key, and to return the encryption data to the client device in response to receiving a processing request from the client device. The secure storage device may comprise a cloud storage device controlled by the client.

The client device may be configured to retrieve the encryption data by: transmitting, to the secure storage device, an authentication request to authenticate the identity of the client; and in dependence on the authentication of the identity of the client, retrieving the encryption data.

Optionally, the at least one server computer may be configured to store first encrypted data associated with a first client in a first database, and second encrypted data associated with a second client in a second database, wherein the first encrypted data is encrypted with a first encryption key associated with the first client, and the second encrypted data is encrypted with a second encryption key associated with the second client.

The encrypted data may be partially encrypted. In this way certain fields within the data set may remain accessible for processing.

Optionally, the encrypted data comprises common encrypted data encrypted using a common encryption key and associated with both a first client and a second client. The server computer may be configured to store a respective encrypted encryption key (EEK) for each of the first client and the second client, wherein each EEK is obtained by encrypting the common encryption key with a respective public key associated with each client. Each client device may be configured to request to process the common encrypted data by: retrieving encryption data comprising a private key associated with the respective public key for the respective client from a secure storage device associated with the respective client; retrieving the respective EEK from the server computer; decrypting the EEK using the private key to obtain the common encryption key; and transmitting the common encryption key to the server computer with the request to process the common encrypted data.

According to another aspect of the disclosure, there is provided a client device for managing a request to process user data on a distributed computing system, comprising: one or more processors; and a memory storing computer executable instructions therein which, when executed by the one or more processors, cause the one or more processors to: receive a user request to process encrypted data associated with a user stored on at least one server computer; retrieve an encryption key associated with the encrypted data from a secure storage device; transmit to the server computer a request based on the user request to process the encrypted data and the encryption key; and receive processed data from the server computer.

According to a further aspect of the disclosure, there is provided a computer- implemented method of managing access to data in a distributed computing system, comprising: storing, at a memory device of a server computer, encrypted data associated with a client; storing, at a secure storage device associated with the client, encryption data indicative of an encryption key associated with the encrypted data; requesting by a client device to process the encrypted data by: retrieving the encryption data from the secure storage device, and transmitting to the server computer a request to process the encrypted data and the encryption key; retrieving, by the server computer, the encrypted data responsive to receiving the request, fulfilling, by the server computer, the processing request to determine processed data using the encryption key.

The method may comprise the server computer deleting the encryption key following completion of the processing request.

Optionally, the method comprises the server computer delivering the processed data to a requested destination.

The method may comprise the server computer encrypting the processed data prior to delivery.

Optionally, the client computer retrieving the encryption data comprises transmitting, to the secure storage device, an authentication request to authenticate the identity of the client; and in dependence on the authentication of the identity of the client, retrieving the encryption data.

The server computer storing the encrypted data may comprise storing common encrypted data encrypted using a common encryption key and associated with both a first client and a second client, and the server computer storing a respective encrypted encryption key (EEK) for each of the first client and the second client, wherein each EEK is obtained by encrypting the common encryption key with a respective public key associated with each client.

According to a further aspect of the disclosure, there is provided computer software which, when executed, is arranged to perform any of the previous methods.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Embodiments of the invention are further described hereinafter with reference to the accompanying drawings, in which:

FIG. 1 is a block diagram of a system for managing access to data in a distributed computing system according to an embodiment of the invention;

FIG. 2 is a block diagram of a server suitable for use in an embodiment of the invention;

FIG. 3 is a block diagram of a client device suitable for use in an embodiment of the invention;

FIG. 4 is a block diagram of an alternative embodiment of the invention;

FIG. 5 is a flow chart of a method according to an embodiment of the invention;

FIG. 6 is a process flow diagram of a method according to an embodiment of the invention; and

FIG. 7 is a block diagram of a further embodiment of the invention.

### DETAILED DESCRIPTION

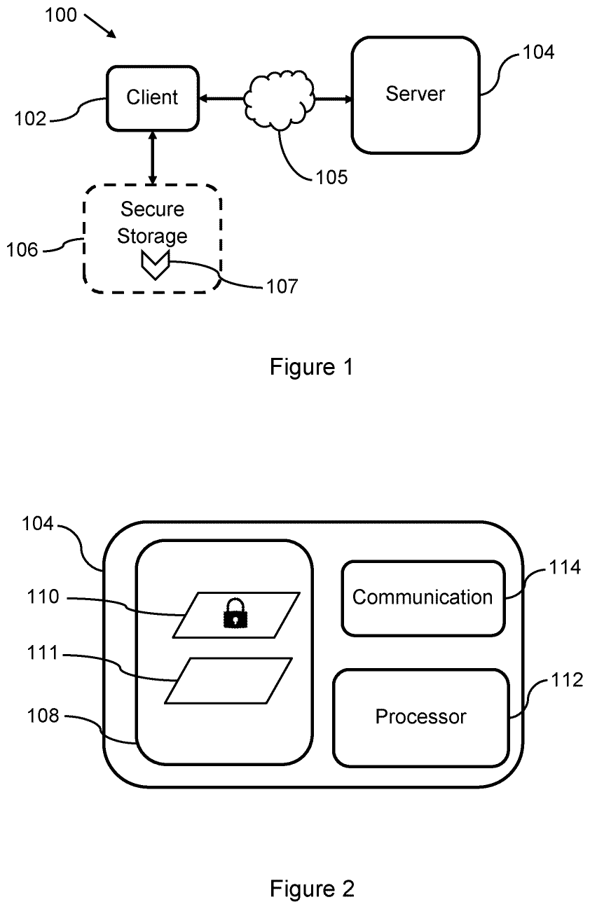

Referring to FIG. 1, there is shown a block diagram of a system, indicated generally by the reference numeral 100, for managing access to data in a distributed computing system according to the disclosure. The system 100 comprises a client device 102 and a server computer 104 which are adapted to communicate with each other. The 30 client device 102 and the server computer 104 may communicate via a network 105 such as the internet or other suitable network such as a private network, an industrial control network, an in-car network or the like. The server computer 104 may be remote from the client device 102. The client device 102 may also communicate with a secure storage device 106 which stores encryption data 107 indicative of an encryption key. The secure storage device 106 may be configured to return the encryption data 107 to the client device 102 in response to receiving a processing request from the client device. The system 100 may operate as part of a cloud service, including a private cloud service, public cloud service, hybrid cloud or other cloud service. In this way, the server computer 104 may be implemented by a cloud server within a cloud service. The client device 102 and the server computer 104 may be owned, controlled and/or operated by separate entities. The server computer 104 may be a multi-tenant device.

Referring to FIG. 2, there is shown a block diagram of the server computer 104.

The server computer 104 comprises a memory device 108, which in turn stores data associated with a client. The memory device may comprise transient and long term memory, for example, the transient memory may be volatile memory and the long term memory may be non-volatile memory. The transient memory may be used while handling requests but would not be used for storage of the client data. Long term memory may be used for storing the client data. The data may comprise encrypted data 110 and unencrypted data 111. The server computer 104 further comprises a processor 112 and a communication module 114. The data may comprise a data set which is partially encrypted. In an example, a partially encrypted data set may be useful to facilitate some tables remaining accessible for worker processes that run in the background such as importing bank feeds in real-time. The server computer 104 may be provided as part of a cloud service.

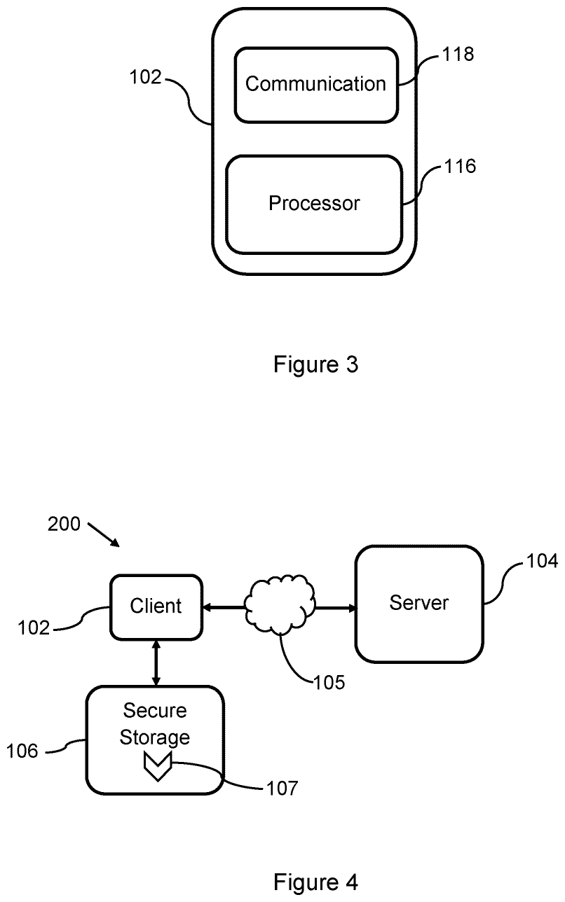

Referring to FIG. 3, there is shown a block diagram of the client device 102. The client device 102 comprises a client processor 116 and a client communication module 118. The system 100 may comprise client devices 102 associated with a plurality of clients. Multiple client devices 102 may be associated with a single client.

The client device 102 is configured to request to process encrypted data 110. The client device 102 is adapted to retrieve encryption data 107 indicative of an encryption key associated with the encrypted data 110 from the secure storage device 106 associated with the client. The client device is adapted to obtain the encryption key using the data 107 indicative of an encryption key. This may comprise decryption of an encrypted version of the encryption key. The client device 102 is adapted to transmit the encryption key and a request to process the encrypted data to the server computer 104. The client device may be configured to receive a user request to process encrypted data associated with a user stored on at least one server computer 104. Retrieving the encryption data may comprise the client device 102 transmitting, to the secure storage device 106, an authentication request to authenticate the identity of the client, client device and/or user; and in dependence on the authentication of the identity, retrieving the encryption data.

On receiving the request and encryption key from the client device 102, the server computer 104 is configured to retrieve the encrypted data 110, decrypt the encrypted data 110 using the encryption key, and fulfil the processing request to determine processed data. In this way, the server computer 104 can only process the encrypted data when it has received a request and key from the client device 102.

The server computer 104 is configured such that the encryption key is not persisted on the server computer 104. As such, the server computer is configured to ensure the key is only processed or stored by or on the server computer 104 in a transient manner. The encryption key may be stored in transient memory, but will not be stored at a long-term memory location in the server computer 104. Facilitating the non-persistence of the encryption key may comprise security practices such as deleting the encryption key from all memory once it is no longer required for the processing the request, not logging the key, configuring the server such that the encryption key is transient in memory as a secure string, using tools to analyse and detect sensitive data in logs or databases. Preventing the key from being logged may be done by implementing customised logging code that would log other aspects of the request but not the encryption key. Processing the key as a secure string may be achieved through suitable coding, including defining the variable in a suitable manner. For example, for code written in C#, the key may be defined as a SecureString variable type.

The decrypted client data is not persisted in memory on the server computer 104. For example, if a processing request requires the server computer 104 to return data to the client, this is done using transient memory such that that data is not persisted.

Once the processed data has been determined, the server computer is further configured to deliver the processed data to a requested destination. The requested destination may be the client 102, long term memory of the server computer 104, or another destination. It may be retained on the server or transmitted to the client device or elsewhere, depending on the request. The processed data may be encrypted with the encryption key if it is to remain stored on the server computer 104, however, the processed data may not require encryption and as such may be stored without encryption. For example, the processed data may be intended for public consumption and will not need to be encrypted. Similarly, if the processed data is to be transmitted to the client device or another recipient, it may be encrypted prior to transmission but it is not essential. Where encryption of the processed data is to be carried out, the deletion of the encryption key is delayed until the encryption has been carried out. In an example, the processed data may represent updated values for existing data, while on another example, it may represent new data. The decrypted client data may be re-encrypted or totally deleted, as appropriate.

The secure storage device 106 may be remote from the client device, may be comprised within the client device, or other suitable arrangement. The secure storage device 106 may be a third party storage device. The secure storage device 106 may comprise a cloud storage device controlled by the client. For example, the secure storage device may comprise a third-party service such as OneDrive from Microsoft. Alternatively, the secure storage device may be comprised within the client device 10, may be comprised within a peripheral device to the client device 102, or otherwise local to the client device 102.

The encryption data 107 indicative of an encryption key may comprise data to allow the encrypted data to be decrypted. It may comprise the encryption key itself, may comprise an encrypted version of the encryption key, or other data to indirectly provide the encryption key. In an example, the encryption key could be stored in a further location and the encryption data comprises an intermediate key for retrieval of the encryption key from that further location.

In use, the user of a client device 102 may generate, at the client device 102, a data processing request for data associated with the client stored in an encrypted manner at a server computer 104. The client device 102 retrieves data indicative of an encryption key for the encrypted data from a secure storage device 106, and transmits the request and encryption key for use in decrypting the data to the server computer 104. The server computer 104 decrypts the user's encrypted data and processes the decrypted data according to the request to generate the processed data. The processed data is then either stored on the server computer 204 or transmitted back to the client device 102, or to another recipient. The processed data may be encrypted using the same encryption key or a different key before storage or transmission. When the server computer is finished handing the processing request, it deletes the encryption key. In this way, the server computer 104 only has access to the client's data when the client has requested that the data be processed.

Referring to FIG. 4, there is shown a block diagram of an alternative system, indicated generally by the reference numeral 200, for managing access to data in a distributed computing network according to the disclosure. The system 200 comprises the client device 102, the server computer 104, and the secure storage device 106. The alternative system 200 of FIG. 4 is similar to and operates in a similar manner to the system described in relation to the FIGS. 1, 2 and 3.

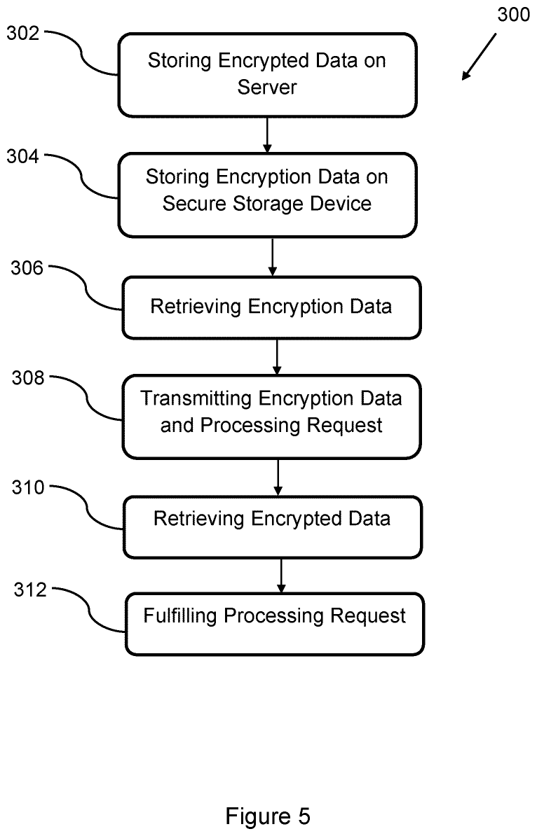

Referring to FIG. 5, there is shown a flow chart of a computer-implemented method, indicated generally by the reference numeral 300, of managing access to data in a distributed computing network. The method 300 described in relation to FIG. 5 may be implemented in the system 100 for managing access to data in a distributed computing network as described herein in relation to FIGS. 1, 2 and 3 or the system 200 described in relation to FIG. 4, however, it will be understood that it is not limited to such a system. At block 302, encrypted data is stored on a memory device on a server computer, such as the server computer 104 of FIG. 2. At block 304, encryption data indicative of an encryption key associated with the encrypted data is stored on a secure storage device associated with the client, such as secure storage device 106 of FIG. 1. The method 300 further includes a client device, such as the client device 102 of FIG. 3, requesting to process the encrypted data, where such a request comprises, at block 306, the client device retrieving the encryption data from the secure storage device and, at block 308, transmitting to the server computer a request to process the encrypted data and the encryption key. At block 310, the method comprises, responsive to receiving the request at block 308, the server computer retrieving the encrypted data. At block 312, the method comprises the server computer fulfilling the processing request to determine processed data using the encryption key. Thereafter the method may comprise encrypting the processed data and/or transmitting it to the client device or elsewhere. When finished handling the processing request, the server may delete the encryption key.

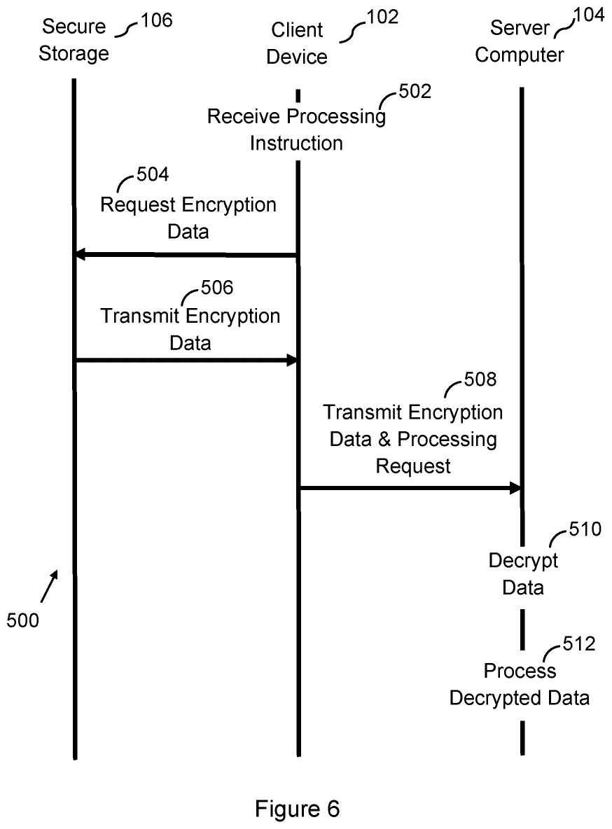

Referring to FIG. 6, there is shown a process flow diagram illustrating a method according to the disclosure. The diagram shows a process, indicated generally by the reference numeral 500, for a method according to the disclosure between the client device 102, secure storage device 106, and server computer 104. The process 500 begins with the client device 102 receiving 502 a processing instruction. The processing instruction may be for example generated by a user of the client device 102, or in another example, may be generated by a process, system or the like running on the client device 102. The processing instruction relates to data associated with the client that is stored on a server computer 104. The server computer 104 may be remote from the client location and operated by an entity other than the client. The server computer 104 may comprise data from parties other than the client associated with the client device 102.

In response to the processing instruction, the client device 102 sends 504 a request for encryption data to a secure storage device 106. The request may include authorisation data for the client device 102 to allow the secure storage device 106 to release the encryption data. At 506, the secure storage device 106 transmits the encryption data to the client device 102. The secure storage device 106 may verify an authorisation provided by the client device 102 before transmitting the encryption data.

At 508, on receipt of the encryption data, the client device 102 transmits the data to allow decryption of the client's data and a request to process the client's data according to the processing instruction to the server computer 104.

At 510, on receipt of the request, the server computer 104 decrypts the client's data, and at 512 processes the decrypted data according to the received request.

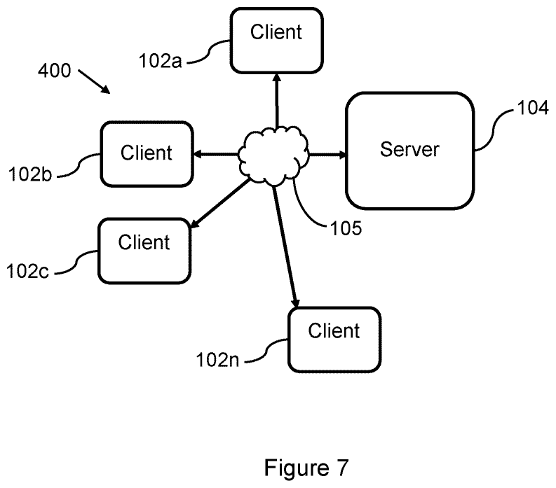

Referring to FIG. 7, there is shown a block diagram of an alternative system, indicated generally by the reference numeral 400, for managing access to data in a distributed computing network according to the disclosure. The distributed computing network may comprise a cloud service, for example, such that the server computer is operated on a cloud server. The system 400 comprises a plurality of client devices 102a, 102b, 102c, . . . , 102n, and the server computer 104. The server computer 104 may be configured to store first encrypted data associated with a first client 102a in a first database, and second encrypted data associated with a second client 102b in a second database, wherein the first encrypted data is encrypted with a first encryption key associated with the first client, and the second encrypted data is encrypted with a second encryption key associated with the second client. As such, the server computer 104 may comprise one or more memory devices, which in turn may store data associated with one or more clients.

Each of the client devices 102a, 102b, 102c, . . . , 102n has access to a secure storage device, the same or similar to that discussed in relation to previous figures. Each of the plurality of client devices 102a, 1102b, 102c, . . . , 102n may be adapted to access a separate secure storage device, or some or all of the plurality of client devices 102a, 102b, 102c, . . . , 102n may share a secure storage device. For clarity of illustration, the secure storage devices are not shown in this figure. The alternative system 400 of FIG. 7 operates in a similar manner to the system described in relation to the FIGS. 1, 2 and 3.

In another example, there is provided a secure method in accordance with the disclosure for two or more clients to have access to shared or common encrypted data. For example, multiple users from a single organisation may share data; or a user may wish for a third party to work with that user's data. The encrypted data may include encrypted data encrypted using a common encryption key and associated with a plurality of clients. Each client intended to have access to the shared data has an associated public and private key pair. The server computer 104 may be configured to store a respective encrypted encryption key (EEK) for each of the authorised clients, wherein each EEK is obtained by encrypting the common encryption key with the respective public key associated with each client. In such an arrangement, the encryption data for a respective client comprises, directly or indirectly, the private key associated with the respective public key for the respective client. A client device 102 may be configured to retrieve this encryption data from a secure storage device 106 associated with the respective client;

and further configured to retrieve the respective EEK from the server computer 104. The client device may decrypt the EEK using the private key to obtain the common encryption key; and transmit the common encryption key to the server computer 104 with the request to process the common encrypted data. In this way, an encryption key for common data is stored in an encrypted format on the server, and a “client key” to decrypt it is retrieved from the secure storage device and transmitted to the server computer 104 to decrypt the encrypted encryption key.

Throughout the specification, a client may be understood to refer to the entity that owns certain data stored on a server. The client may a single person or an organisation. The client may have one or more client devices, each of the which may operate as a client device according to the disclosure to manage processing of the client's data on the server. One or more users may be associated with the client, wherein each user may have access to one or more of the client devices. The relationships between users and client devices and the ways in which they may be required to authenticate themselves to one or more secure storage devices will be apparent to the person skilled in the art and will not be described in detail here.

The client device described in the present disclosure may include a personal communication device such as a mobile phone, a table device or the like; a personal computing device such as a tablet Personal Computer (PC), desktop PC, a laptop computer, or the like; and/or other electronic devices such as a Portable Multimedia Player (PMP), a mobile medical device, a camera, or a wearable device such as a smart watch or smart glasses.

The client device may be a smart home appliance such a television, a refrigerator, a washing machine, a set-top box, a home automation control panel, a security control panel, a TV box such as Apple TV™, or Google TV™), a gaming console (e.g., Xbox™, PlayStation™) or the like.

The client device may include at least one of various medical devices such as portable medical measuring devices, imaging devices or the like; a navigation device; a Global Positioning System (GPS) receiver; a Flight Data Recorder (FDR); an automotive infotainment device; security devices; vehicular head units; industrial or home robots; Automatic Teller's Machines (ATMs); Point Of Sales (POS) devices; Internet of Things devices such as a utility meter, a fire alarm, a thermostat, a street light or the like; or the like.

According to various embodiments of the disclosure, an client device may include at least one of a part of furniture or building/structure, an electronic board, an electronic signature receiving device, a projector, or various measurement devices (e.g., devices for measuring water, electricity, gas, or electromagnetic waves). According to an embodiment of the present disclosure, the electronic device may include one of or a combination of the above-listed devices. According to an embodiment of the present disclosure, the electronic device may be a flexible electronic device. Electronic devices according to embodiments of the present disclosure are not limited to the above-listed devices, and may include new electronic devices depending on the development of technology.

The term ‘processor’ is to be interpreted broadly to include a CPU, processing unit, ASIC, logic unit, or programmable gate array etc, and may refer to a single processor or a combination of several processors. Certain aspects of the disclosure may be implemented using machine-readable instructions which may, for example, be executed by a general purpose computer, a special purpose computer, an embedded processor or processors of other programmable data processing devices to realize the functions described in the description and diagrams. In particular, a processor or processing apparatus may execute the machine-readable instructions. Thus, functional modules of the apparatus and devices may be implemented by a processor executing machine readable instructions stored in a memory, or a processor operating in accordance with instructions embedded in logic circuitry. The functional modules may be implemented in a single processor or divided amongst several processors.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A system for managing access to data in a distributed computing system, comprising:
at least one server computer comprising a memory device configured to store encrypted data associated with a client; and
at least one client device configured to request to process the encrypted data by:
retrieving encryption data indicative of an encryption key associated with the encrypted data from a secure storage device associated with the client, and
transmitting to the server computer a request to process the encrypted data and the encryption key;
wherein the server computer is configured to, responsive to receiving the request:
retrieve the encrypted data, decrypt the encrypted data using the encryption key, and
fulfil the processing request to determine processed data.

2. The system of claim 1, wherein the server computer is configured to delete the encryption key from the server computer following completion of the processing request.

3. The system of claim 1 wherein the server computer is further configured to deliver the processed data to a requested destination.

4. The system of claim 3 wherein the server computer is configured to encrypt the processed data prior to delivery.

5. The system of claim 1, further comprising the secure storage device configured to store the encryption data indicative of the encryption key, and to return the encryption data to the client device in response to receiving a processing request from the client device.

6. The system of claim 5, wherein the secure storage device comprises a cloud storage device controlled by the client.

7. The system of claim 1, wherein the client device is configured to retrieve the encryption data by:
transmitting, to the secure storage device, an authentication request to authenticate the identity of the client; and
in dependence on the authentication of the identity of the client, retrieving the encryption data.

8. The system of claim 1, wherein the at least one server computer is configured to store first encrypted data associated with a first client in a first database, and second encrypted data associated with a second client in a second database,
wherein the first encrypted data is encrypted with a first encryption key associated with the first client, and the second encrypted data is encrypted with a second encryption key associated with the second client.

9. The system of claim 1, wherein the encrypted data is partially encrypted.

10. The system of claim 1, wherein:
the encrypted data comprises common encrypted data encrypted using a common encryption key and associated with both a first client and a second client.

11. The system of claim 10, wherein the server computer is configured to store a respective encrypted encryption key (EEK) for each of the first client and the second client, wherein each EEK is obtained by encrypting the common encryption key with a respective public key associated with each client.

12. The system of claim 11, wherein each client device is configured to request to process the common encrypted data by:
retrieving encryption data comprising a private key associated with the respective public key for the respective client from a secure storage device associated with the respective client;
retrieving the respective EEK from the server computer;
decrypting the EEK using the private key to obtain the common encryption key; and
transmitting the common encryption key to the server computer with the request to process the common encrypted data.

13. The system of claim 1, wherein the distributed computing system comprises a cloud service.

14. A client device for managing a request to process user data on a distributed computing system, comprising:
one or more processors; and
a memory storing computer executable instructions therein which, when executed by the one or more processors, cause the one or more processors to:
receive a user request to process encrypted data associated with a user stored on at least one server computer;
retrieve an encryption key associated with the encrypted data from a secure storage device;
transmit to the server computer a request based on the user request to process the encrypted data and the encryption key; and
receive processed data from the server computer.

15. A computer-implemented method of managing access to data in a distributed computing system, comprising:
storing, at a memory device of a server computer, encrypted data associated with a client;
storing, at a secure storage device associated with the client, encryption data indicative of an encryption key associated with the encrypted data;
requesting by a client device to process the encrypted data by:
retrieving the encryption data from the secure storage device, and
transmitting to the server computer a request to process the encrypted data and the encryption key;
retrieving, by the server computer, the encrypted data responsive to receiving the request,
fulfilling, by the server computer, the processing request to determine processed data using the encryption key.

16. The method of claim 15 comprising the server computer deleting the encryption key following completion of the processing request.

17. The method of claim 15 comprising the server computer delivering the processed data to a requested destination.

18. The method of claim 17 comprising the server computer encrypting the processed data prior to delivery.

19. The method of claims 15 wherein the client computer retrieving the encryption data comprises
transmitting, to the secure storage device, an authentication request to authenticate the identity of the client; and
in dependence on the authentication of the identity of the client, retrieving the encryption data.

20. The method of any of claims 15 wherein the server computer storing the encrypted data comprises storing common encrypted data encrypted using a common encryption key and associated with both a first client and a second client, and
the server computer storing a respective encrypted encryption key (EEK) for each of the first client and the second client, wherein each EEK is obtained by encrypting the common encryption key with a respective public key associated with each client.

21. The method of claim 20 comprising at least one of the client devices requesting to process the common encrypted data by:
retrieving encryption data comprising a private key associated with the respective public key for the respective client from a secure storage device associated with the respective client;
retrieving the respective EEK from the server computer;
decrypting the EEK using the private key to obtain the common encryption key; and
transmitting the common encryption key to the server computer with the request to process the common encrypted data.

22. Computer software which, when executed, is arranged to perform a method according to any of claims 15.
